(19) United States
(12) Patent Application Publication
(10) Pub. No.: US 2014/0244017 A1
(43) Pub. Date: Aug. 28, 2014

(54) DETERMINING ITEMS TO BUILD BASED ON AN INTERNET OF THINGS (IOT) NETWORK INVENTORY AND BUILDING THE DETERMINED ITEMS USING A 3D PRINTER

(71) Applicant: QUALCOMM Incorporated, San Diego, CA (US)

(72) Inventors: Raphael Ruben FREIWIRTH, San Diego, CA (US); Mohammed Ataur Rahman SHUMAN, San Diego, CA (US); Sandeep SHARMA, San Diego, CA (US)

(73) Assignee: QUALCOMM Incorporated, San Diego, CA (US)

(21) Appl. No.: 14/186,982

(22) Filed: Feb. 21, 2014

Related U.S. Application Data
(60) Provisional application No. 61/769,159, filed on Feb. 25, 2013.

(51) Int. Cl. B29C 67/00

(52) U.S. Cl. CPC B29C 67/0051
USPC 700/100

(57) ABSTRACT

The disclosure generally relates to determining items to build based on inventory in an Internet of Things (IoT) network and using a 3D printer to build the determined items. In particular, inventory in the IoT network may be monitored to predict replacement needs associated with certain items in the IoT network inventory and determine further inventory needs (e.g., based on items that malfunction or break, upcoming calendar events, etc.). In one embodiment, in response to determining that additional inventory items may be needed in the IoT network, licenses and 3D printer blueprints to build the items may be obtained (internally and/or externally) and 3D printing may be scheduled to build the items (e.g., based on a priority scheme, timing criteria, resource availability, etc.), whereby the items may be added to the IoT network inventory when the 3D printer completes 3D print jobs to produce the items.

### CROSS-REFERENCE TO RELATED APPLICATIONS

The present application for Patent claims the benefit of Provisional Patent Application No. 61/769,159 entitled “DETERMINING AND BUILDING ITEMS TO BUILD USING A 3D PRINTER,” filed Feb. 25, 2013, and assigned to the assignee hereof and hereby expressly incorporated herein by reference in its entirety.

### TECHNICAL FIELD

Various embodiments described herein are directed to determining items to build based on an Internet of Things (IoT) network inventory and using a 3D printer to build the determined items and thereby manage the IoT network inventory.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

The disclosure generally relates to determining items to build based on inventory in an Internet of Things (IoT) network and using a 3D printer to build the determined items. In particular, various embodiments may generally monitor inventory in an IoT network, predict replacement needs associated with certain inventory items in the IoT network, and determine additional inventory needs in the IoT network (e.g., based on a malfunctioning or broken inventory item, upcoming calendar events, etc.). As such, in response to determining that additional items may be needed in the IoT network inventory, licenses and 3D printer blueprints to build the items may be obtained (internally and/or externally) and 3D printing to build the items may then be scheduled (e.g., based on a priority scheme, timing criteria, resource availability, etc.), whereby the items may be added to the IoT network inventory in response to the 3D printer completing one or more 3D print jobs and thereby producing the items.

According to another exemplary aspect, the mechanisms disclosed herein to determine items to build based on inventory in an IoT network and use a 3D printer to build the determined items may involve determining the one or more items to build using the 3D printer based on inventory requirements in an IoT network, acquiring 3D printer blueprints associated with the one or more items, scheduling one or more jobs on the 3D printer in response to acquiring the 3D printer blueprints and rights to build the one or more items using the 3D printer blueprints, wherein scheduling the one or more jobs causes the 3D printer to build the one or more items using the 3D printer blueprints, and adding the one or more items to the IoT network inventory in response to the 3D printer completing the one or more scheduled jobs to build the one or more items. For example, in one embodiment, a user associated with the IoT network may inherently have the rights to build the one or more items using the 3D printer blueprints based on the user having designed the 3D printer blueprints associated with the one or more items. Furthermore, in that use case, the 3D printer blueprints designed by the user associated with the IoT network may be deposited in a repository external to the IoT network and registered with the external repository to control access that users external to the IoT network have with respect to using the 3D printer blueprints deposited in the external repository (e.g., under an open source license such that the users external to the IoT network are free to use the 3D printer blueprints subject to compliance with the open source license, under a paid license such that the users external to the IoT network granted the rights to use the 3D printer blueprints subject to payment terms that are defined in the paid license, etc.). Alternatively, the 3D printer blueprints associated with the one or more items may be acquired from a repository external to the IoT network and the 3D printer blueprints and a license that grants the rights to build the one or more items using the 3D printer blueprints may be retrieved from the external repository, or the 3D printer blueprints and the license may be retrieved from an internal repository located in the IoT network if the 3D printer blueprints and the license were previously obtained from the external repository.

According to another exemplary aspect, the inventory in the IoT network may be monitored to determine the items to build using the 3D printer, wherein the determined items may comprise replacements for one or more one or more objects in the monitored inventory that are detected to be malfunctioning or broken. In another example, objects in the monitored inventory that are likely to malfunction or break within a certain time period may be predicted, wherein the items to build may comprise replacements for the one or more objects likely to malfunction or break. In still another example, the items to build may comprise inventory needs associated with an upcoming event in a calendar associated with a user of the IoT network. In any case, the 3D printer may be scheduled according to resource usage and resource availability in the IoT network, according to one or more timing criteria based on schedules associated with one or more users of the IoT network, or other suitable factors. For example, if the items to build include a first item to replace a first object that has malfunctioned or broken and a second item to replace a second object that is predicted to malfunction or break within a certain time period, the 3D printer jobs to build the first item and the second item may be scheduled to prioritize the first job over the second job such that replacing the first object that has malfunctioned or broken has a higher priority than replacing the second object that is predicted to malfunction or break.

According to another exemplary aspect, a method for managing an IoT inventory may comprise determining one or more items that correspond to one or more inventory needs in an IoT network, attempting to obtain 3D printing materials associated with the one or more items and rights to build the one or more items using a 3D printer, and presenting one or more alternative items to satisfy the one or more inventory needs in response to determining that one or more of the 3D printing materials associated with the one or more items or the rights to build the one or more items using the 3D printer are unavailable. As such, in response to a user selecting the one or more alternative items, the method may further comprise attempting to obtain 3D printing materials associated with the alternative items and rights to build the alternative items using the 3D printer and scheduling one or more jobs to build the one or more alternative items on the 3D printer in response to obtaining the 3D printing materials and the rights to build the alternative items using the 3D printer.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIGS. 1A-1E illustrates exemplary high-level system architectures of a wireless communications system, according to various aspects of the disclosure.

FIG. 2A illustrates an exemplary Internet of Things (IoT) device, according to various aspects of the disclosure, while FIG. 2B illustrates an exemplary passive IoT device, according to various aspects of the disclosure.

FIG. 3 illustrates an exemplary communication device that includes logic configured to perform functionality, according to various aspects of the disclosure.

FIG. 4 illustrates an exemplary server, according to various aspects of the disclosure.

FIGS. 5A-B illustrate high-level system architectures of exemplary communications systems that may be used to determine items to build based on an IoT network inventory and using a 3D printer to build the determined items, according to various aspects of the disclosure.

FIGS. 6A-B illustrate exemplary methods for determining items to build based on an IoT network inventory and using a 3D printer to build the determined items, according to various aspects of the disclosure.

FIG. 7 illustrates an exemplary method for determining alternative sources to obtain needed inventory items in an IoT network when 3D printing to build the needed inventory items may be unavailable, according to various aspects of the disclosure.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

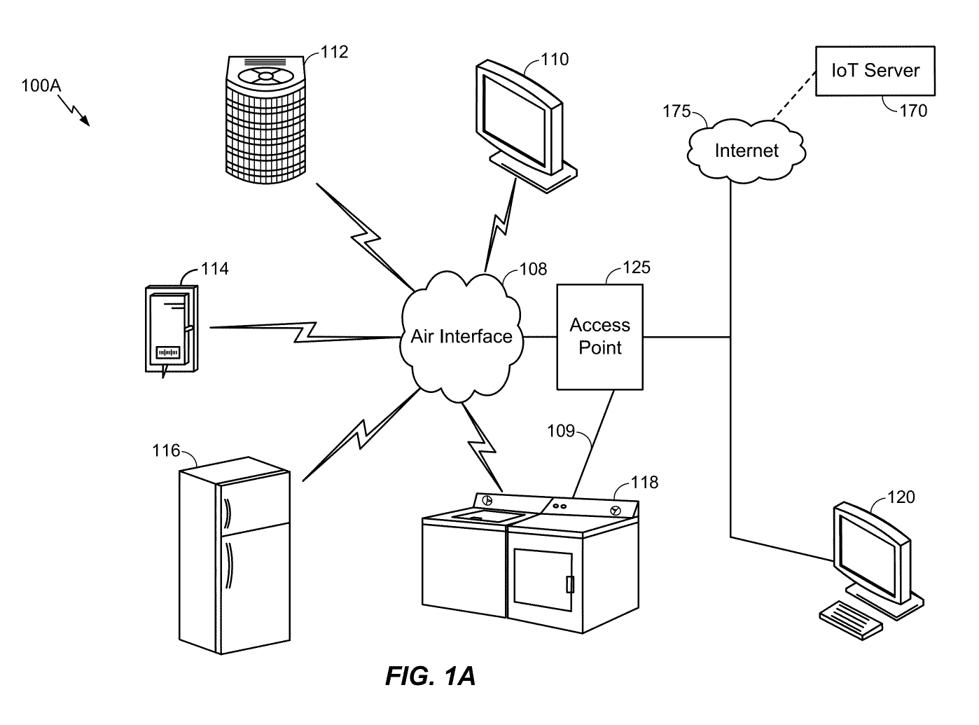

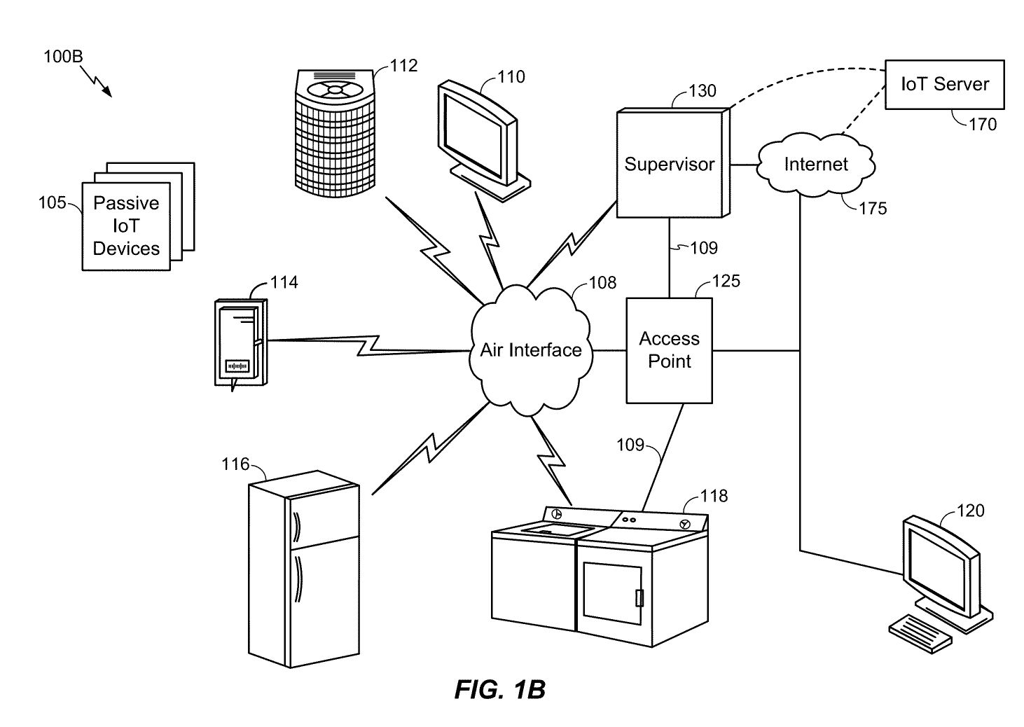

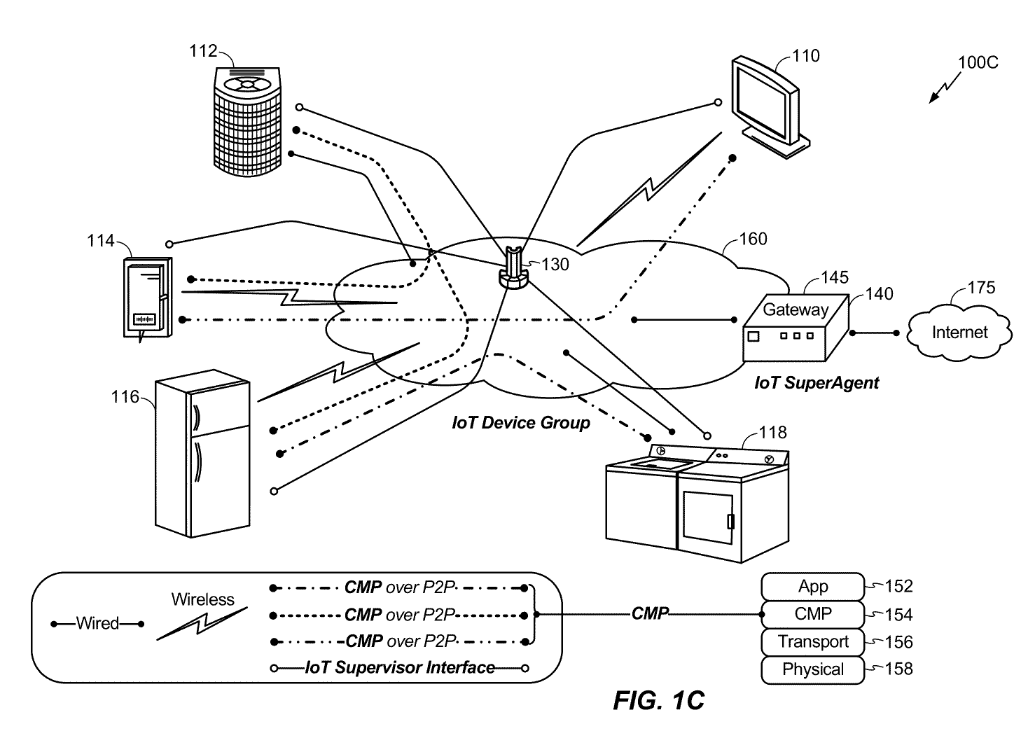

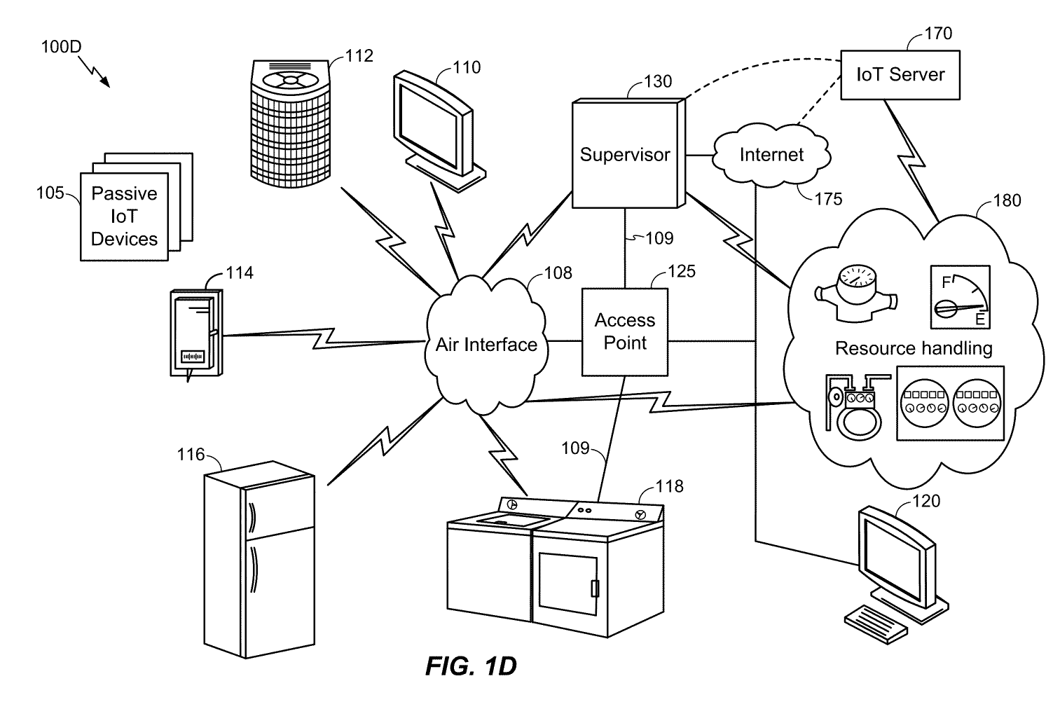

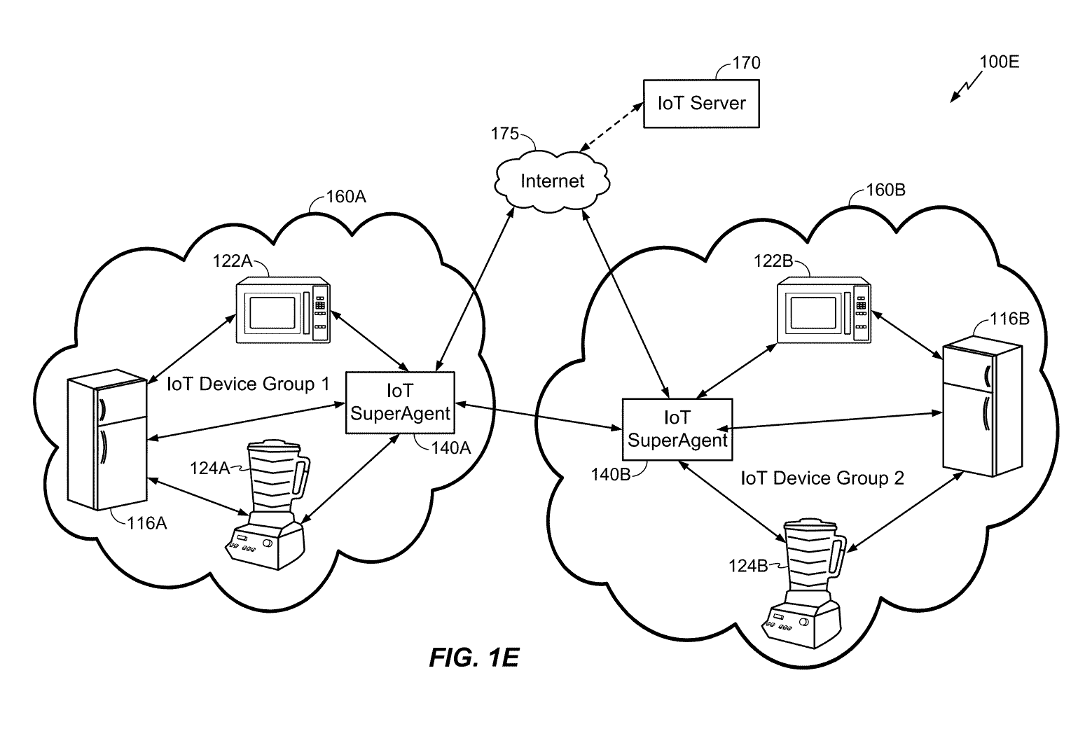

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of IoT devices 110-120 may be configured with a communication interface independent of air interface 108 and direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In one embodiment, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each have an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communication system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT group 160. An IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-C shown in FIGS. 1-C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-C illustrated in FIGS. 1A-C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-D shown in FIGS. 1-D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-D illustrated in FIGS. 1A-D, respectively.

The communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

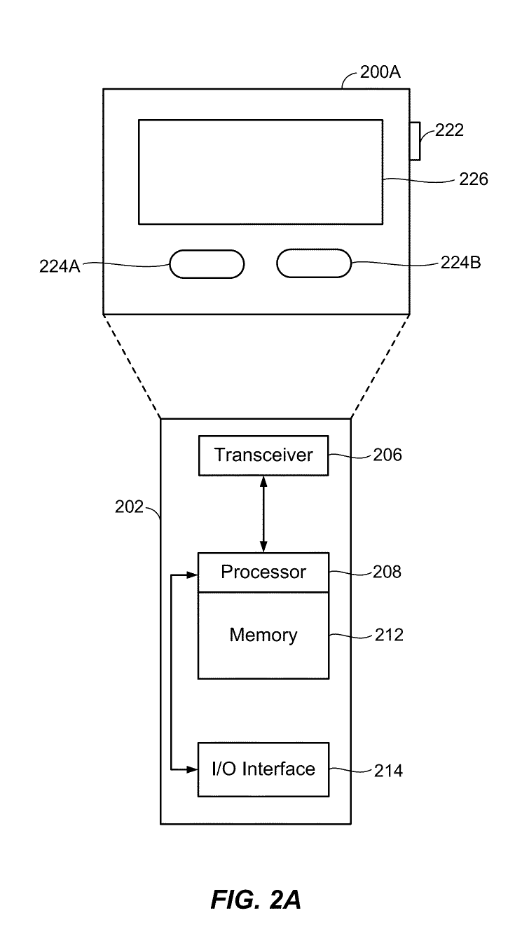

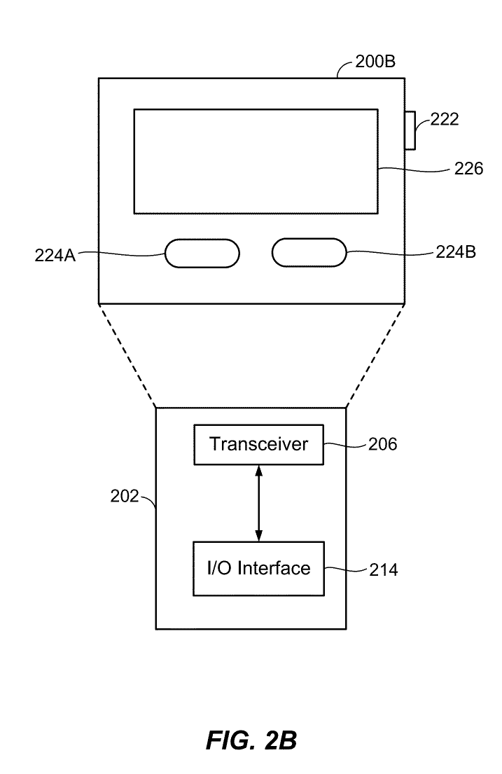

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200B may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

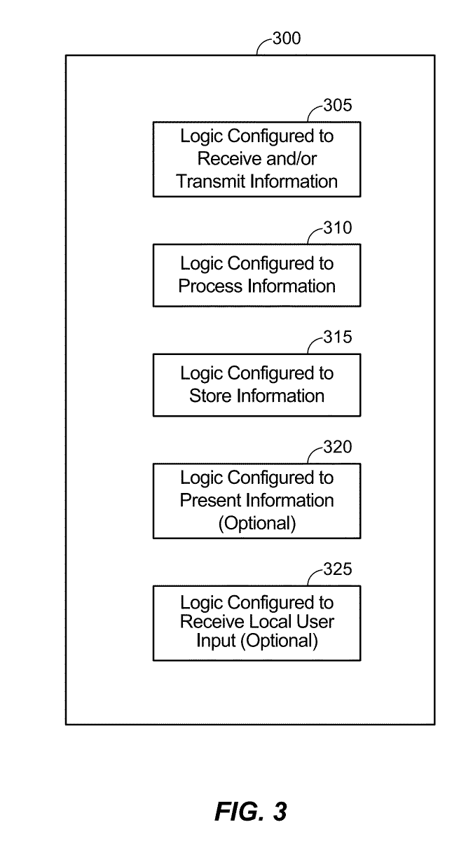

FIG. 3 illustrates a communication device 300 that includes logic configured to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-B of FIGS. 1A-B.

Referring to FIG. 3, the communication device 300 includes logic configured to receive and/or transmit information 305. In an example, if the communication device 300 corresponds to a wireless communications device (e.g., IoT device 200A and/or passive IoT device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the logic configured to present information 320 can include the display 226. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the logic configured to receive local user input 325 can include the buttons 222, 224A, and 224B, the display 226 (if a touchscreen), etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

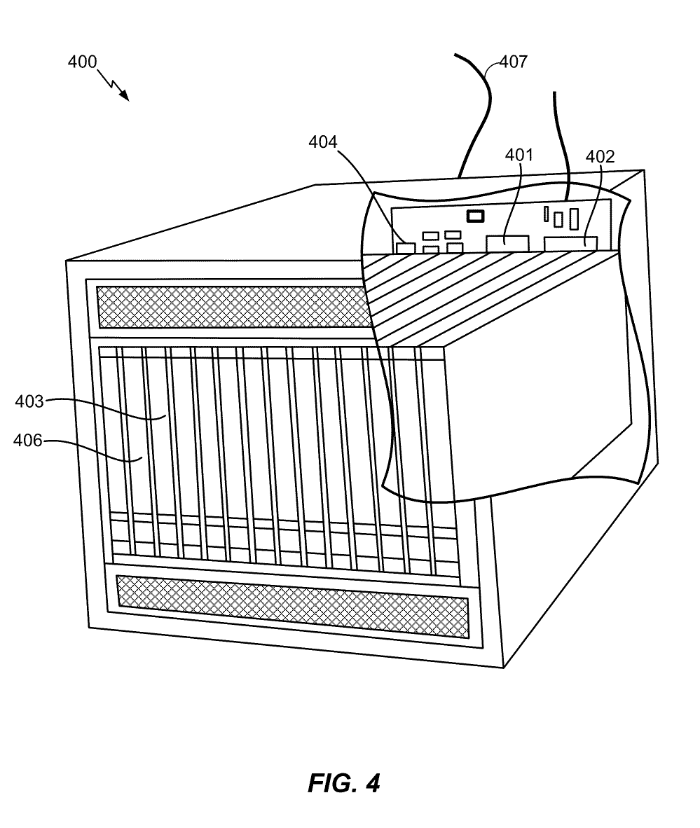

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

IP based technologies and services have become more mature, driving down the cost and increasing availability of IP. This has allowed Internet connectivity to be added to more and more types of everyday electronic objects. The IoT is based on the idea that everyday electronic objects, not just computers and computer networks, can be readable, recognizable, locatable, addressable, and controllable via the Internet.

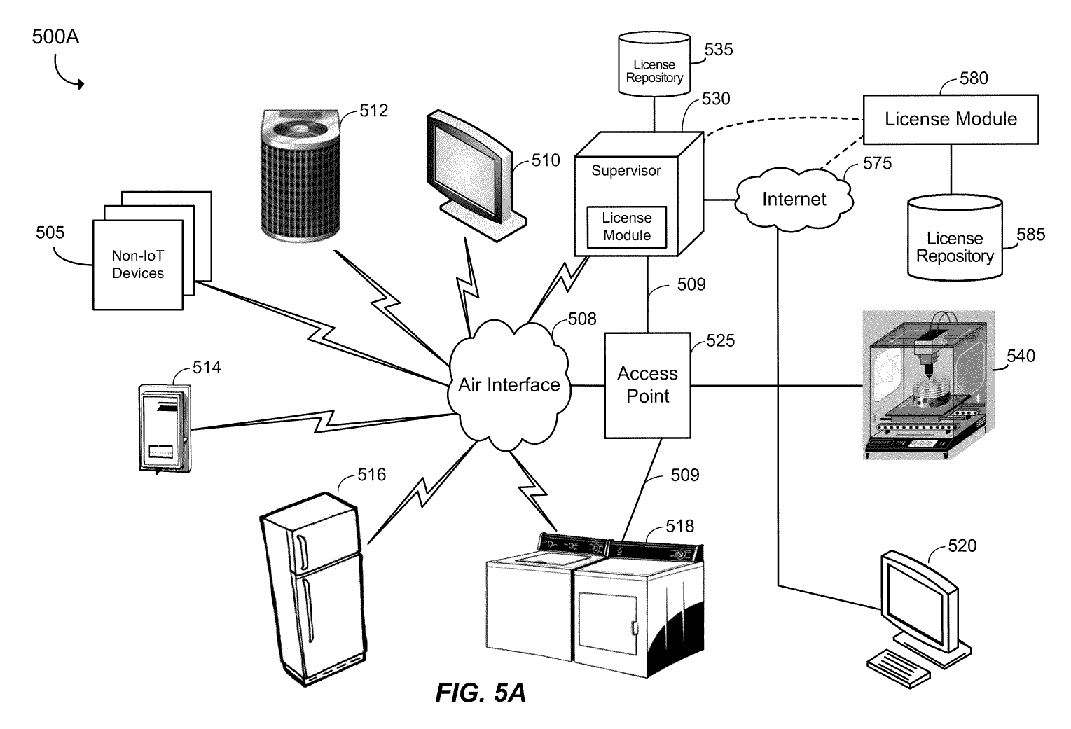

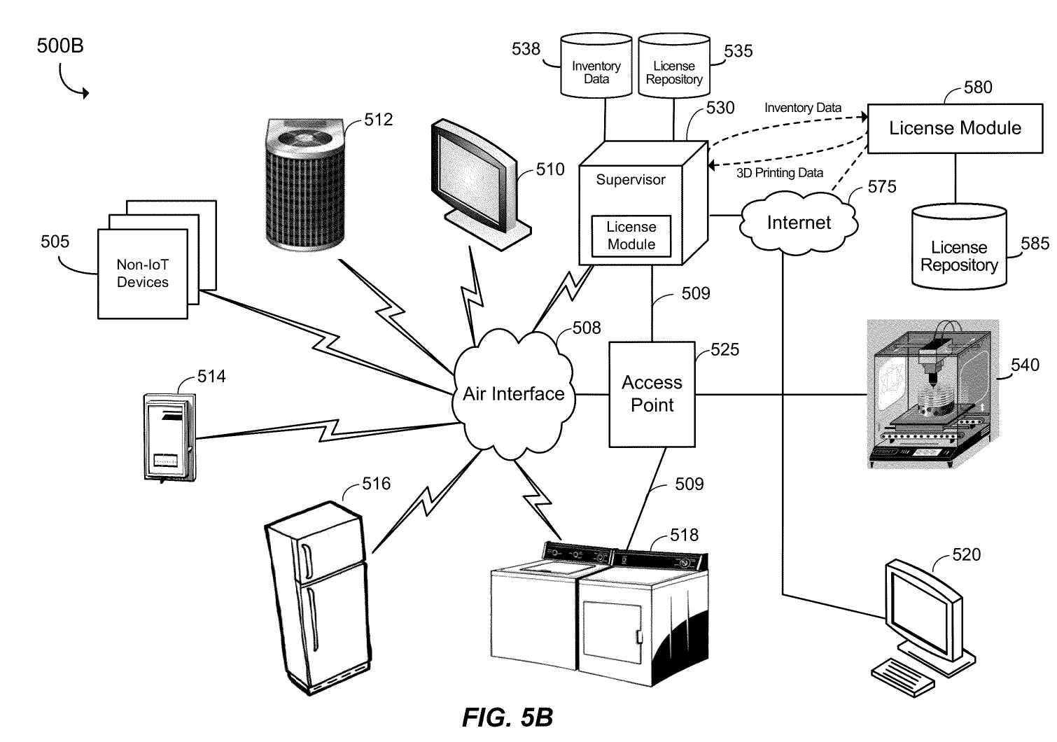

In accordance with an aspect of the disclosure, FIGS. 5A-B illustrate high-level architectures of exemplary communications systems that may be used to determine items to build based on an IoT network inventory and using a 3D printer 540 to build the determined items. In general, the communications systems 500A-B shown in FIGS. 5A-B may include various components that are the same and/or substantially similar to the communications systems 100A-E shown in FIGS. 1A-E, which were described in greater detail above (e.g., various IoT devices, including a television 510, outdoor air conditioning unit 512, thermostat 514, refrigerator 516, and washer and dryer 518, that are configured to communicate with an access point 525 over an air interface 508 and/or a direct wired connection 509, a computer 520 that directly connects to the Internet 575 and/or connects to the Internet through access point 525, etc.). As such, for brevity and ease of description, various details relating to certain components in the communications systems 500A-B shown in FIGS. 5A-B may be omitted herein to the extent that the same or similar details have already been provided above in relation to FIGS. 1A-E.

In one embodiment, the communications systems 500A-B shown in FIGS. 5A-B may include a 3D printer 540 that can construct or otherwise build three-dimensional solid objects having virtually any shape or form using a digital model that may be represented in a 3D printer blueprint. For example, the 3D printer 540 may generally use additive processes to deposit material in successive layers using virtual blueprints (e.g., created using computer aided design or other suitable modeling software) that can represent digital cross-sections that the 3D printer 540 can use to guide the additive process to build solid objects. Accordingly, in various embodiments, the communications systems 500A-B shown in FIGS. 5A-B may be used to determine inventory items to build using the 3D printer 540 and appropriately coordinate resource usage in the communications systems 500A-B to schedule or otherwise control building the inventory items. For example, in one embodiment, the systems 500A-B may include a supervisor device 530 that can monitor inventory in the communications systems 500A-B, which may comprise an IoT network having an inventory that includes various IoT devices and/or non-IoT devices, predict replacement needs associated with certain inventory items in the IoT network, and determine additional inventory needs in the IoT network (e.g., based on inventory items that malfunction or break, based on upcoming calendar events, etc.).

Accordingly, in response to determining that additional inventory items may be needed in the IoT network, the supervisor device 530 may employ a license module to retrieve licenses and 3D printer blueprints to build the inventory items from an internal license repository 535 and/or communicate with an external license module 580 to retrieve the licenses and 3D printer blueprints to build the inventory items from an external license repository 585. For example, in one embodiment, the licenses may come with one or more actual devices when they are plugged into the IoT network and therefore available on request if and/or when the licenses may be needed. In another example, devices that are plugged into the IoT network may link to an external location where the licenses and 3D printing blueprints, which may be available subject to expiration dates, used-by dates, or in accordance with other terms that may be defined in warranties or other such contracted obligations (e.g., a purchased item may come with one or more licenses and blueprints that can be used as the purchased item approaches the end of its life span).

In one embodiment, the supervisor device 530 may be used to observe, monitor, control, or otherwise manage the communications systems 500A-B and thereby determine an inventory that exists within the IoT network. Furthermore, the supervisor device 530 may communicate with various other components in the systems 500A-B to determine what inventory needs may exist, identify an appropriate source to obtain 3D printer blueprints or other suitable information to create or replicate the needed inventory, and obtain appropriate rights (e.g., a license) to create or replicate the needed inventory. In one embodiment, in response to suitably obtaining the 3D printer blueprints and appropriate rights to create or replicate the needed inventory, the supervisor device 530 may then coordinate scheduling creation or replication of the needed inventory via the 3D printer 540 based on a priority scheme, timing criteria, resource availability, or other suitable factors and appropriately update the inventory that exists within the IoT network in response to the 3D printer 540 successfully creating physical objects that correspond to the needed inventory. Additionally, as shown in FIG. 5B, the supervisor device 530 may store inventory data 538 that corresponds to the inventory that exists within the IoT network, the inventory needs in the IoT network, and/or any other suitable inventory data 538 that may be relevant to the current inventory or needed inventory within the IoT network. As such, in one embodiment, the inventory data 538 or other suitable information indicating a possible inventory need based on the inventory data 538 may be sent to the external license module 580 or another suitable server-side entity in order to setup 3D printing needs that may be presently needed and/or 3D printing needs that may arise in the future (e.g., the inventory data 538 may be used to obtain all relevant information that may be needed to create or replicate items represented in the inventory data 538 such that the items can be created or replicated on demand if and/or when the need may arise).

In one embodiment, the supervisor device 530 may generally communicate with various other components in the communications systems 500A-B to observe or otherwise monitor the inventory that exists within the IoT network. As such, in response to determining that a particular inventory item needs replacement (e.g., a glass broke and needs to be replaced), the supervisor device 530 may consult the internal license module to determine whether the internal license repository 535 contains appropriate rights and blueprints that can be used to replicate the inventory item. For example, if the broken glass was designed by the owner of the IoT network, the blueprint associated therewith may be stored in the license repository 535 and external rights to replicate the glass may not be needed because the IoT network owner has inherent rights to the glass design. In another example, if the broken glass is part of a set and the appropriate licenses and blueprints were previously obtained when another glass in the set broke, the license and appropriate blueprints may have previously been stored in the internal license repository 535. Alternatively, if the internal license repository 535 does not already contain appropriate licenses and/or blueprints that can be used to replicate the inventory item, the supervisor device 530 may contact the external license module 580 to determine whether the blueprints and/or licenses to replicate the inventory item are available, and if so, appropriately obtain the blueprints and/or licenses (e.g., from external license repository 585), which may then be stored within internal license repository 535. Furthermore, in one embodiment, certain 3D printer blueprints that are created internally may be appropriately registered with the external license module 580 and/or deposited in the external license repository 585 to allow or otherwise control other users' access thereto (e.g., the 3D printer blueprints may be made open source and freely available to the public subject to compliance with appropriate open source licenses, made available for purchase on a per-build basis, made available for unlimited builds following a one-time purchase, etc.).

In one embodiment, the supervisor device 530 may further provide predictive, “self-healing,” or otherwise proactive inventory management features. For example, in one embodiment, the supervisor device 530 may have knowledge relating to upcoming events based on information contained in a user calendar and determine additional inventory that may be needed based on that knowledge (e.g., a child has an upcoming birthday and gives the parent a wish list, which may be entered into an appropriate input device with a value range that specifies purchasing criteria, and the supervisor device 530 may then analyze the items in the wish list and obtain licenses and/or blueprints to build certain items in the wish list based on availability, cost, or other factors, schedule building the items via the 3D printer 540, notify the parent when the items have been built or request feedback from the parent, such as if a cost to build the items exceeds a predefined limit or better alternatives are available, etc.). In another example, the supervisor device 530 may know that the IoT network owner has an upcoming dinner party based on a calendar event and monitor the IoT network inventory to ensure that sufficient items will be available for all guests to the dinner party (e.g., in response to inviting more people to the dinner party, the supervisor device 530 may check that the inventory includes sufficient plates, glassware, and other items for everyone expected to attend and obtain appropriate licenses and blueprints to build additional inventory to the extent needed). In another example, the supervisor device 530 may have knowledge relating to the expected amount of time that certain inventory items may last or how much certain inventory items can be used prior to needing replacement and proactively find the blueprints and licenses needed to build the replacement parts before they are needed. In still another example, the supervisor device 530 may have knowledge that certain inventory items are malfunctioning or likely to malfunction or break in the near future, in which case the supervisor device 530 may similarly find the blueprints and licenses needed to build replacement parts before the inventory items actually malfunction or break.

In one embodiment, in response to suitably obtaining the licenses and blueprints needed to build replacement inventory items, the supervisor device 530 may then schedule building the inventory items via the 3D printer 540. In particular, the supervisor device 530 may determine resource utilization, timing criteria, or other suitable scheduling factors within the communication systems 500A-B, wherein building the inventory items via the 3D printer 540 may be scheduled based thereon. For example, the supervisor device 530 may schedule building toys for the child's upcoming birthday at night to ensure that the child will not be awake when the building occurs (e.g., based on knowledge relating to when the child usually sleeps) and notify the parent to remove the toys from the 3D printer 540 before the child wakes up (e.g., based on knowledge relating to when the child usually wakes up). In another example, the supervisor device 530 may determine that the licenses and/or 3D printer blueprints needed to build certain items are unavailable, in which case the user may be prompted to indicate whether an equivalent brand or type would be acceptable. In still another example, the supervisor device 530 may determine that certain inventory items are needed more urgently than others (e.g., building a replacement for an air conditioner part that has actually broken may be more urgent than building a replacement for another inventory item that may malfunction in the near future but has yet to fail). As such, the supervisor device 530 may generally determine needed inventory items based on observed, scheduled, and/or predicted conditions within the communication systems 500A-B and coordinate building the needed inventory items based on urgency, priority, resource availability, timing criteria, or other suitable factors.

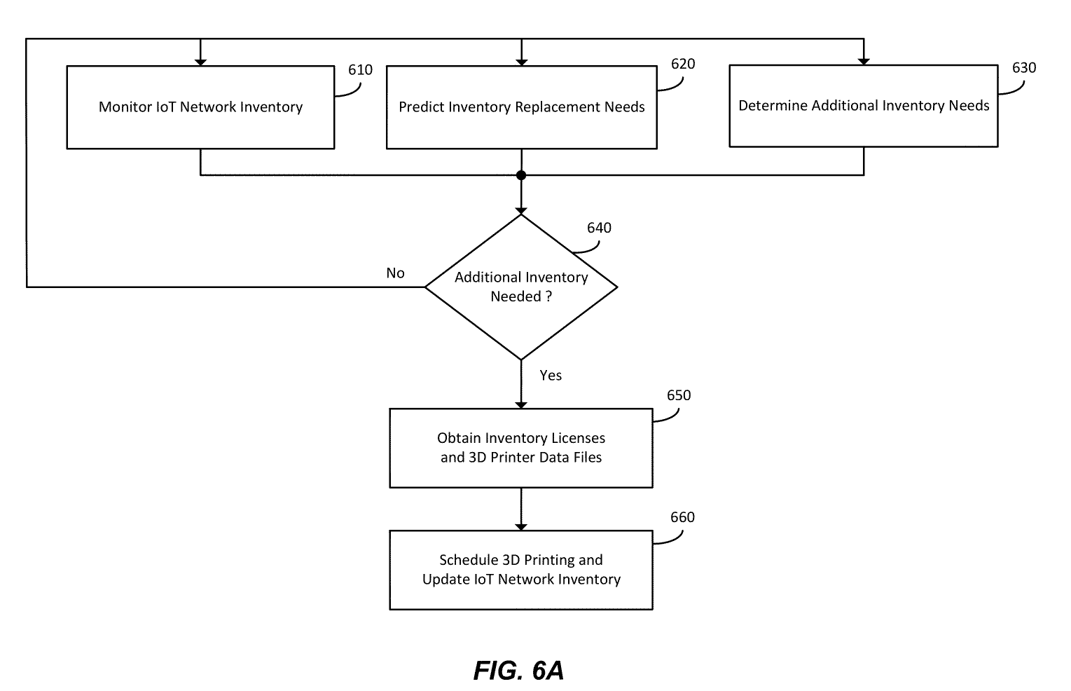

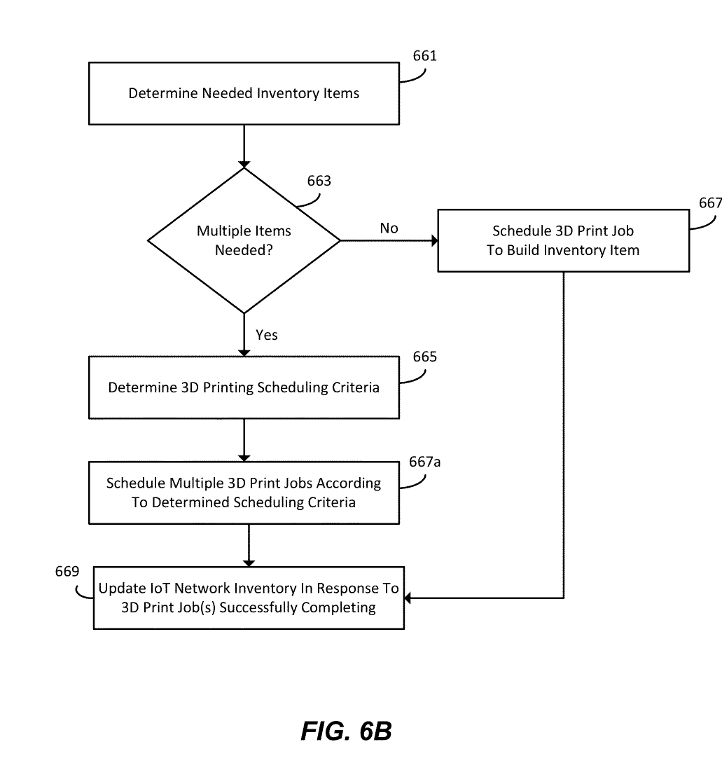

In accordance with another aspect of the disclosure, FIG. 6A illustrates an exemplary method for determining items to build based on an IoT network inventory and using a 3D printer to build the determined items. In one embodiment, a supervisor device may generally observe or otherwise monitor an inventory that exists within an IoT network at block 610, predict inventory replacement needs at block 620, and/or determine additional inventory needs at block 630. For example, in one embodiment, the supervisor device may otherwise monitor the inventory that exists within the IoT network at block 610 to determine whether certain inventory items may be malfunctioning, broken, or otherwise in need of replacement. Furthermore, at block 620, the supervisor device may use knowledge relating to the expected amount of time that certain inventory items may last or how much certain inventory items can be used prior to needing replacement and thereby predict whether certain inventory items need replacement. Additionally, at block 630, the supervisor device may use knowledge relating to upcoming events, planned activities, or other information relevant to an inventory state to determine additional inventory needs (e.g., based on information in a user calendar). As such, the supervisor device may then determine whether additional inventory may be needed at block 640, wherein if no additional inventory is presently needed, the supervisor device may return to blocks 610, 620, and 630 to continue monitoring the IoT network inventory, predicting inventory replacement needs, and determining other inventory needs until additional inventory may be needed.

Otherwise, in response to the supervisor device determining that additional inventory may be needed at block 640, the supervisor device may then employ an internal and/or external license module to retrieve appropriate licenses and 3D printer blueprints to build the inventory items at block 650. For example, if the additional inventory was originally designed by the owner of the IoT network, the blueprint associated therewith may be stored in and retrieved from an internal license repository because the IoT network owner has inherent rights to the original glass design. In another example, if the broken glass was part of a set and the appropriate licenses and blueprints were previously obtained when another glass in the set broke, the license and appropriate blueprints may have previously been stored in the internal license repository. Alternatively, if the internal license repository does not contain appropriate licenses and/or blueprints that can be used to replicate the inventory item, the supervisor device may contact an external license module to determine whether the blueprints and/or licenses to replicate the inventory item are available, and if so, appropriately obtain the blueprints and/or licenses at block 650.

In one embodiment, in response to suitably obtaining the licenses and blueprints needed to build replacement inventory items, the supervisor device may then schedule building the inventory items via a 3D printer at block 660. In particular, the supervisor device may determine resource utilization, timing criteria, or other suitable scheduling factors and scheduling building the inventory items via the 3D printer based thereon (e.g., based on knowledge about patterns in the schedules associated with users of the IoT network, the urgency associated with the need to build various inventory items, etc.). As such, the supervisor device may generally determine needed inventory items based on observed, scheduled, and/or predicted needs and coordinate building the needed inventory items based on various scheduling criteria.

For example, FIG. 6B illustrates certain exemplary operations that may be performed in connection with block 660 in FIG. 6A to coordinate building the needed inventory items based on various scheduling criteria. In particular, as shown in FIG. 6B, the supervisor device may generally determine the needed inventory items at block 661 and then determine whether the needed inventory items include multiple different items that may require multiple jobs to be scheduled on the 3D printer at block 663. As such, in response to determining that the needed inventory items include multiple items such that multiple jobs are needed to build the various needed items, the supervisor device may then determine one or more criteria to schedule the 3D printing jobs at block 665 and schedule multiple 3D printing jobs to build the various needed items according to the determined scheduling criteria at block 667a, which may depend on the various factors described in further detail above (e.g., prioritizing jobs to replace items that have high utilization rates or have started to malfunction over jobs to replace items that have low utilization rates or are simply predicted to possibly malfunction in the future). Alternatively, in response to determining that the needed inventory items only include one item such that a need to prioritize multiple jobs may not exist, the supervisor device may schedule a 3D printing job to build the needed item at block 667b, which may still depend on certain criteria (e.g., in the birthday present example given above, the 3D print job may be scheduled to occur overnight). In any case, in response to the 3D print job(s) successfully completing, the supervisor device may then appropriately update the IoT network inventory to include the new items that were built using the 3D printer at block 669.

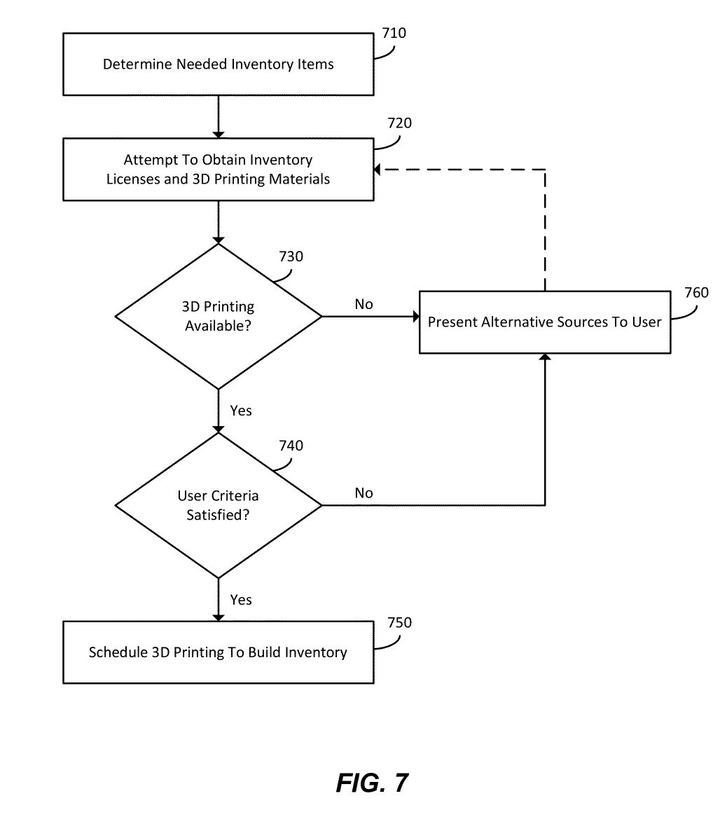

According to another aspect of the disclosure, FIG. 7 illustrates an exemplary method for determining alternative sources to obtain needed inventory items in an IoT network when 3D printing to build the needed inventory items may be unavailable. In particular, the supervisor device may generally determine one or more needed inventory items at block 710 in substantially the same manner described in further detail above and then attempt to obtain licenses and 3D printing materials (e.g., blueprints) to build the needed items using the 3D printer at block 720. In one embodiment, at block 730, the supervisor device may then determine whether 3D printing is available for the needed items. For example, 3D printing may be unavailable when blueprints to create or replicate the items using the 3D printer do not exist or appropriate licenses or rights cannot be obtained, in which case the supervisor device may present alternative sources to obtain the needed items to a user at block 760 (e.g., whether other similar types of materials and/or licenses can be used, whether equivalent brands are acceptable, etc.). Furthermore, even if the blueprints to create or replicate the items using the 3D printer and licenses or other rights to build the items are available, the supervisor device 740 may determine whether any user-specified criteria are satisfied at block 740 and similarly present alternative sources to obtain the needed items at block 760 if the user-specified criteria are not satisfied. For example, suppose that an owner establishes a $5 limit to rebuild a mug and the license and material to build the mug costs $7. In another example, the owner of the mug blueprint may no longer want that blueprint to be used (e.g., due to a liability in the way that the mug was constructed) and instead want users to employ a modified mug blueprint that has a similar design (e.g., one that modifies the original design to fix the defect that resulted in the liability). As such, at block 760, the user could be prompted to indicate whether the alternative would be acceptable and the process may return to block 720 in the event that the user accepts the proposed alternative. Of course, if the blueprints to create or replicate the items using the 3D printer, the licenses are available, and the user-specified criteria are satisfied, the supervisor device may simply schedule the 3D printing to build the inventory items at block 750 in substantially the same manner described in further detail above.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for building Internet of Things (IoT) inventory items using a three-dimensional (3D) printer, comprising:
determining one or more items to build using the 3D printer based on inventory requirements in an IoT network;
acquiring 3D printer blueprints associated with the one or more items;
scheduling one or more jobs on the 3D printer in response to acquiring the 3D printer blueprints and rights to build the one or more items using the 3D printer blueprints, wherein scheduling the one or more jobs causes the 3D printer to build the one or more items using the 3D printer blueprints; and
adding the one or more items to the IoT network inventory in response to the 3D printer completing the one or more scheduled jobs to build the one or more items.

2. The method recited in claim 1, further comprising:
determining that a user associated with the IoT network inherently has the rights to build the one or more items using the 3D printer blueprints based on the user having designed the 3D printer blueprints associated with the one or more items.

3. The method recited in claim 2, further comprising:
depositing the 3D printer blueprints designed by the user associated with the IoT network in a repository external to the IoT network; and
registering the deposited 3D printer blueprints with the external repository to control access that users external to the IoT network have with respect to using the 3D printer blueprints deposited in the external repository.

4. The method recited in claim 3, wherein the 3D printer blueprints are registered under an open source license such that the users external to the IoT network are free to use the 3D printer blueprints subject to compliance with the open source license.

5. The method recited in claim 3, wherein the 3D printer blueprints are registered under a paid license such that the users external to the IoT network granted the rights to use the 3D printer blueprints subject to payment terms that are defined in the paid license.

6. The method recited in claim 1, wherein acquiring the 3D printer blueprints associated with the one or more items comprises:
contacting a repository external to the IoT network; and
retrieving the 3D printer blueprints and a license that grants the rights to build the one or more items using the 3D printer blueprints from the external repository.

7. The method recited in claim 6, wherein acquiring the 3D printer blueprints associated with the one or more items comprises:
determining that the 3D printer blueprints and a license that grants the rights to build the one or more items using the 3D printer blueprints were previously obtained from a repository external to the IoT network; and
retrieving the 3D printer blueprints and the license from an internal repository located in the IoT network.

8. The method recited in claim 1, wherein determining the one or more items to build using the 3D printer comprises:
monitoring the inventory in the IoT network; and
detecting one or more objects in the monitored inventory that are malfunctioning or broken, wherein the one or more determined items comprise replacements for the one or more malfunctioning or broken objects.

9. The method recited in claim 1, wherein determining the one or more items to build using the 3D printer comprises:
monitoring the inventory in the IoT network; and
predicting one or more objects in the monitored inventory that are likely to malfunction or break within a certain time period, wherein the one or more determined items comprise replacements for the one or more objects likely to malfunction or break.

10. The method recited in claim 1, wherein determining the one or more items to build using the 3D printer comprises:
identifying an upcoming event in a calendar associated with a user, wherein the one or more determined items comprise inventory needs associated with the identified upcoming calendar event.

11. The method recited in claim 1, wherein the one or more jobs are scheduled according to resource usage and resource availability in the IoT network.

12. The method recited in claim 1, wherein the one or more jobs are scheduled according to one or more timing criteria based on schedules associated with one or more users of the IoT network.

13. The method recited in claim 1, wherein:
the one or more determined items comprise a first item to replace a first object in the IoT network inventory that has malfunctioned or broken and a second item to replace a second object in the IoT network inventory that is predicted to malfunction or break within a certain time period,
the one or more jobs scheduled on the 3D printer comprise a first job to build the first item and a second job to build the second item, and
the one or more jobs are scheduled to prioritize the first job over the second job such that replacing the first object that has malfunctioned or broken has a higher priority than replacing the second object that is predicted to malfunction or break.

14. The method recited in claim 1, further comprising:
notifying a user associated with the IoT network that the one or more items have been built in response to the 3D printer completing the one or more scheduled jobs.

15. An Internet of Things (IoT) network, comprising:
one or more inventory items;
a three-dimensional (3D) printer; and
at least one device having one or more processors configured to determine one or more items to build using the 3D printer based on inventory requirements in the IoT network, acquire 3D printer blueprints associated with the one or more items, schedule one or more jobs on the 3D printer in response to acquiring the 3D printer blueprints and rights to build the one or more items using the 3D printer blueprints, wherein scheduling the one or more jobs causes the 3D printer to build the one or more items using the 3D printer blueprints, and add the one or more items to the IoT network inventory in response to the 3D printer completing the one or more scheduled jobs to build the one or more items.

16. The IoT network recited in claim 15, wherein the one or more processors are further configured to determine that a user associated with the IoT network inherently has the rights to build the one or more items using the 3D printer blueprints based on the user having designed the 3D printer blueprints associated with the one or more items.

17. The IoT network recited in claim 16, wherein the one or more processors are further configured to:
deposit the 3D printer blueprints designed by the user associated with the IoT network in a repository external to the IoT network; and
register the deposited 3D printer blueprints with the external repository to control access that users external to the IoT network have with respect to using the 3D printer blueprints deposited in the external repository.

18. The IoT network recited in claim 17, wherein the 3D printer blueprints are registered under an open source license such that the users external to the IoT network are free to use the 3D printer blueprints subject to compliance with the open source license.

19. The IoT network recited in claim 17, wherein the 3D printer blueprints are registered under a paid license such that the users external to the IoT network granted the rights to use the 3D printer blueprints subject to payment terms that are defined in the paid license.

20. The IoT network recited in claim 15, wherein the one or more processors are further configured to:
contact a repository external to the IoT network; and
retrieve the 3D printer blueprints and a license that grants the rights to build the one or more items using the 3D printer blueprints from the external repository.

21. The IoT network recited in claim 20, further comprising:
an internal repository located in the IoT network, wherein the one or more processors are further configured to retrieve the 3D printer blueprints and a license that grants the rights to build the one or more items using the 3D printer blueprints from the internal repository in response to determining that the 3D printer blueprints and the license were previously obtained from a repository external to the IoT network.

22. The IoT network recited in claim 15, wherein the one or more processors are further configured to:
monitor the inventory in the IoT network; and
detect one or more objects in the monitored inventory that are malfunctioning or broken, wherein the one or more determined items comprise replacements for the one or more malfunctioning or broken objects.

23. The IoT network recited in claim 15, wherein the one or more processors are further configured to:
monitor the inventory in the IoT network; and
predict one or more objects in the monitored inventory that are likely to malfunction or break within a certain time period, wherein the one or more determined items comprise replacements for the one or more objects likely to malfunction or break.

24. The IoT network recited in claim 15, wherein determining the one or more items to build using the 3D printer comprises:
identifying an upcoming event in a calendar associated with a user, wherein the one or more determined items comprise inventory needs associated with the identified upcoming calendar event.

25. The IoT network recited in claim 15, wherein the one or more jobs are scheduled according to resource usage and resource availability in the IoT network.

26. The IoT network recited in claim 15, wherein the one or more jobs are scheduled according to one or more timing criteria based on schedules associated with one or more users of the IoT network.

27. The IoT network recited in claim 15, wherein:
the one or more determined items comprise a first item to replace a first object in the IoT network inventory that has malfunctioned or broken and a second item to replace a second object in the IoT network inventory that is predicted to malfunction or break within a certain time period,
the one or more jobs scheduled on the 3D printer comprise a first job to build the first item and a second job to build the second item, and
the one or more jobs are scheduled to prioritize the first job over the second job such that replacing the first object that has malfunctioned or broken has a higher priority than replacing the second object that is predicted to malfunction or break.

28. The IoT network recited in claim 15, wherein the one or more processors are further configured to:
notifying a user associated with the IoT network that the one or more items have been built in response to the 3D printer completing the one or more scheduled jobs.

29. An apparatus, comprising:
means for determining one or more items to build using the 3D printer based on inventory requirements in an IoT network;
means for acquiring 3D printer blueprints associated with the one or more items;
means for scheduling one or more jobs on the 3D printer in response to acquiring the 3D printer blueprints and rights to build the one or more items using the 3D printer blueprints, wherein scheduling the one or more jobs causes the 3D printer to build the one or more items using the 3D printer blueprints; and
means for adding the one or more items to the IoT network inventory in response to the 3D printer completing the one or more scheduled jobs to build the one or more items.

30. A computer-readable storage medium having computer-executable instructions for collaborative group-based decision-making recorded thereon, wherein executing the computer-executable instructions on one or more processors device causes the one or more processors to:
determine one or more items to build using the 3D printer based on inventory requirements in an IoT network;
acquire 3D printer blueprints associated with the one or more items;
schedule one or more jobs on the 3D printer in response to acquiring the 3D printer blueprints and rights to build the one or more items using the 3D printer blueprints, wherein scheduling the one or more jobs causes the 3D printer to build the one or more items using the 3D printer blueprints; and
add the one or more items to the IoT network inventory in response to the 3D printer completing the one or more scheduled jobs to build the one or more items.

31. A method for managing an Internet of Things (IoT) inventory, comprising:
determining one or more items that correspond to one or more inventory needs in an IoT network;
attempting to obtain three-dimensional (3D) printing materials associated with the one or more items and rights to build the one or more items using a 3D printer;
presenting one or more alternative items to satisfy the one or more inventory needs in response to determining that one or more of the 3D printing materials associated with the one or more items or the rights to build the one or more items using the 3D printer are unavailable;
attempting to obtain 3D printing materials associated with the alternative items and rights to build the alternative items using the 3D printer in response to a user selecting the one or more alternative items; and
scheduling one or more jobs to build the one or more alternative items on the 3D printer in response to obtaining the 3D printing materials associated with the alternative items and the rights to build the alternative items using the 3D printer.
